(19) United States
(12) Patent Application Publication
(10) Pub. No.: US 2012/0146908 A1
(43) Pub. Date: Jun. 14, 2012

(54) UNIVERSAL SERIAL BUS MOUSE

(75) Inventors: CHIEN-HUNG LO, Tu-Cheng (TW); HAI-LI WANG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD, Shenzhen City (CN)

(21) Appl. No.: 12/972,500

(22) Filed: Dec. 19, 2010

(30) Foreign Application Priority Data
Dec. 13, 2010 (CN) 201010584981.0

(51) Int. Cl. G09G 5/08

(52) U.S. Cl. 345/163

(57) ABSTRACT

A universal serial bus (USB) mouse includes a USB plug, a USB hub circuit, a mouse control circuit, a wireless router circuit, a wireless network card circuit, and an antenna. The mouse control circuit, the wireless router circuit, and the wireless network card circuit are connected to the USB plug through the USB hub circuit. The antenna is connected between the wireless router circuit and the wireless network card circuit. The wireless router circuit together with the antenna functions as a wireless router. The wireless network card circuit together with the antenna functions as a wireless network card.

### BACKGROUND

1. Technical Field

The present disclosure relates to a universal serial bus (USB) mouse.

2. Description of Related Art

Nowadays, computers are widely used in our life. A computer mouce is one of the most important peripheral device of a computer. Although some computer mice can connect to a computer through a variety of interfaces, nowadays, the USB interface is the most ubiquitous. However, the USB mouse only functions as an input device, therefore, there is room for improvement in the art.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is a block diagram of an embodiment of a universal serial bus (USB) mouse.

FIG. 2 is an isometric, schematic view of the USB mouse of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

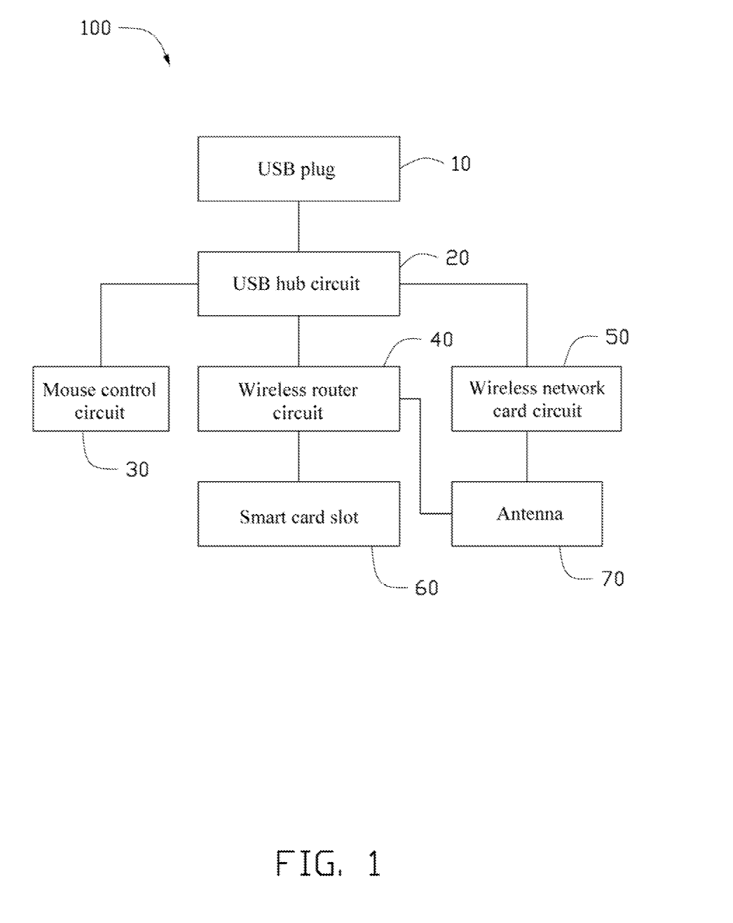

Referring to FIG. 1, an embodiment of a universal serial bus (USB) mouse 100 includes a USB plug 10, a USB hub circuit 20, a mouse control circuit 30, a wireless router circuit 40, a wireless network card circuit 50, a smart card slot 60, and an antenna 70.

The USB plug 10 is connected to a USB interface of a computer (not shown). The USB plug 10 is connected to the mouse control circuit 30, the wireless router circuit 40, and the wireless network card circuit 50, through the USB hub circuit 20. The USB hub circuit 20 functions as a USB hub to allow the USB plug 10 to synchronously communicate with the mouse control circuit 30, the wireless router circuit 40, and the wireless network card circuit 50. The mouse control circuit 30 is used to control the mouse 100 to function as an input device to control the computer. The USB hub circuit 20 and the mouse control circuit 30 both fall within well-known technologies, and are therefore not further described here.

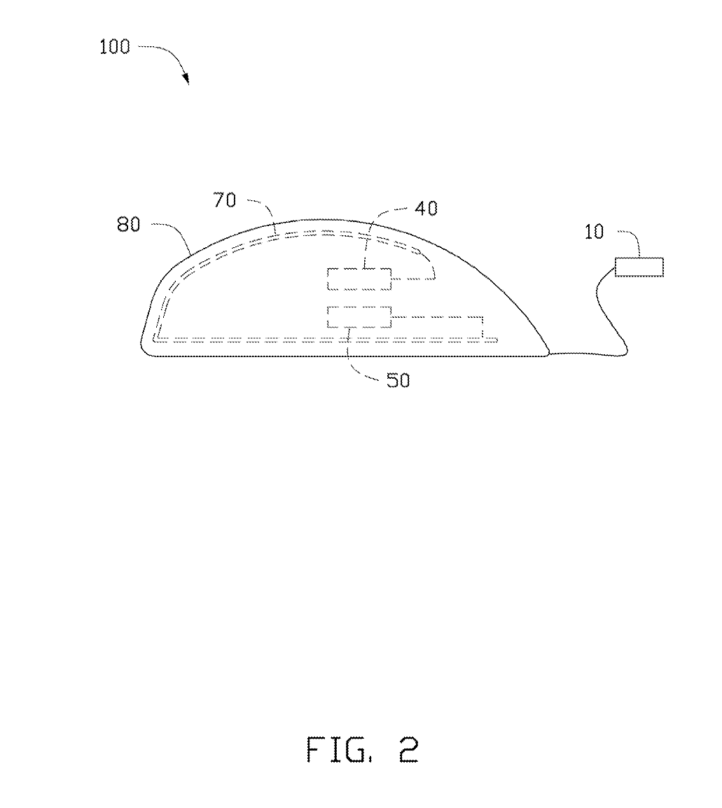

Referring to FIG. 2, the antenna 70 is housed in a case 80 of the mouse 100. In one embodiment, the antenna 70 is designed to substantially surround an inside wall of the case 80, therefore increasing the length of the antenna 70, and thus increasing the signal receiving effect. The antenna 70 is connected to the wireless router circuit 40 and the wireless network card circuit 50, to receive a signal and transmit the received signal to the wireless router circuit 40 and the wireless network card circuit 50.

The wireless router circuit 40 together with the antenna 70 functions as a wireless router, and the wireless network card circuit 50 together with the antenna 70 functions as a wireless network card. The wireless router circuit 40 and the wireless network card circuit 50 both fall within well-known technologies, and are therefore not described here. The smart card slot 60 is connected to the wireless router circuit 40, and receives a smart card (not shown), such as a third-generation smart card, to allow the wireless router circuit 40 access a network authorized by the smart card. In other embodiments, the smart card slot 60 is not used, and then the wireless router circuit 40 can access a network from an external modem.

In use, the USB plug 10 is inserted in the USB interface of the computer, the smart card is inserted in the smart card slot 60, and at this time, the mouse control circuit 30, the wireless router circuit 40, and the wireless network card circuit 50 can work synchronously through the USB hub circuit 20. On one hand, the mouse control circuit 30 can make the mouse 100 function as a normal mouse to control the computer. On the other hand, the wireless router circuit 40 accesses the network authorized by the smart card (or accesses the network from an external modem), and then the wireless router circuit 40 transmits received network signals to the wireless network card circuit 50 through the antenna 70, therefore the computer can access the network, which is very convenient. Furthermore, the computer does not need to have a network card or an antenna installed, which can increase performance of the computer.

It is to be understood, however, that even though numerous characteristics and advantages of the embodiments have been set forth in the foregoing description, together with details of the structure and function of the embodiments, the disclosure is illustrative only, and changes may be made in details, especially in matters of shape, size, and arrangement of parts within the principles of the embodiments to the full extent indicated by the broad general meaning of the terms in which the appended claims are expressed.

What is claimed is:

1. A universal serial bus (USB) mouse comprising:
a USB plug;
a USB hub circuit connected to the USB plug;
a mouse control circuit connected to the USB hub circuit;
a wireless router circuit connected to the USB hub circuit;
a wireless network card circuit connected to the USB hub circuit; and
an antenna connected between the wireless router circuit and the wireless network card circuit;
wherein the wireless router circuit together with the antenna functions as a wireless router, the wireless network card circuit together with the antenna functions as a wireless network card.

2. The USB mouse of claim 1, further comprising a smart card slot connected to the wireless router circuit.

3. The USB mouse of claim 1, wherein the antenna substantially surrounds an inside wall of a case of the USB mouse.
